(19) United States
(12) Patent Application Publication
(10) Pub. No.: US 2004/0247093 A1
(43) Pub. Date: Dec. 9, 2004

(54) System, method, and apparatus for provisioning recorded announcements

(76) Inventors: Karl W. Potts, Birmingham, AL (US); Henry R. White, Jacksonville, FL (US)

Correspondence Address: SCOTT P. ZIMMERMAN, PLLC, PO BOX 3822, CARY, NC, 27519, US

(21) Appl. No.: 10/150,100

(22) Filed: May 20, 2002

(51) Int. Cl. H04M 1/64; G06F 15/16

(52) U.S. Cl. 379/88.17; 709/217

(57) ABSTRACT

A method, system, and apparatus for provisioning recorded announcements onto recorded announcement equipment of a telecommunications network. In one embodiment, a user downloads a desired announcement from a database through a computer network and onto a computer, and then uploads the announcement from the computer to a particular recorded announcement unit. In another embodiment, a user remotely administers a transfer of a digital audio file from a database through a network and to a particular recorded announcement unit. The recorded announcement equipment can reside in any appropriate node of the telecommunications network, including within a central office or within a service node that provides announcements for a plurality of central offices.

### FIELD OF THE INVENTION

The present invention relates to a method, system, and apparatus for provisioning recorded announcements onto recorded announcement equipment of a communications network. More particularly, the present invention relates to a method, system, and apparatus that enable a user to remotely retrieve recorded announcements and load those announcements onto recorded announcement equipment.

### BACKGROUND OF THE INVENTION

Numerous businesses use recorded announcements to convey information to their customers via a communications network. The use of recorded announcements is widespread and rapidly growing in today's global economy. For example, most, if not all, telecommunication companies use hundreds of recorded announcements to notify callers of, for example, call status, service status, available services, employment opportunities, and account balances. Similarly, banking services use thousands of recorded announcements to inform customers of, for example, account status, lending opportunities, payment options, credit rates, billings, and various other services. Most establishments use recorded announcements to route calls, receive automated purchase information, generate sales, perform sales promotions, and provide other automated customer services. Polling services use recorded announcements to respond to calls, issue questions to callers, and generate responses to data entered by callers. Hospitals, governmental agencies, and other large entities often employ recorded announcements both internally and externally for applications with callers. As yet another example, many airline services use hundreds of recorded announcements to inform passengers of flight status, ticket information, and flight information. The travel services industry is another business sector that utilizes systems with recorded announcements. Most travel agencies, car rental services, and hotels handle transactions with recorded announcements. Many companies use “in-house” communication systems with “pick up” phones that play announcements when a user picks up the telephone (e.g., a car rental agency or hotel with a “pick up” telephone at a front desk or reception counter).

Most telecommunication systems employ one or more central offices (CO) on a network. Typically, each central office has recorded announcement equipment coupled to a switch network via a series of trunks. A trigger in the network is used to identify which recorded announcement(s) is (are) required for a communication on the network. The switch network routes incoming calls to a trunk. Each trunk is associated with one or more recorded announcements on the recorded announcement equipment. With existing systems and methods, recorded announcements are loaded on the recorded announcement equipment according to the needs of each central office. In most cases, at least a portion of the announcements that are available at one central office is common to two or more central offices on a network. For example, the announcements for a particular central office may be common to all of the telephone subscribers serviced on a local access transport area (LATA).

Currently, when new recorded announcements become available, or existing recorded announcements require maintenance and the like, work assignments must be made to update announcements in one or more of the central offices that use those announcements. When this occurs, using known systems, an announcement tape must be loaded in each central office. This arrangement is often time consuming and costly. For example, maintaining recorded announcements at numerous locations imposes significant labor efforts to assign and maintain announcements in each central office.

FIG. 1 is a schematic illustration of an exemplary architecture of known systems. In this example, subscribers of a telephone service provider access specific recorded announcements coupled to trunks in a central office 100. For example, caller 101 dials a code, e.g., “1+” or “800”, that causes a trigger in router 110 or alternatively in the central office 100, to initiate a query for a recorded announcement from recorded announcement equipment 150. Similarly, another caller 102 dials a defined service number, and router 110, recognizing this number, routes the call to an automated attendant function at central office 100. Finally, based on a sudden service outage for cellular calls in a certain region, cellular telephone caller 103 is identified as a cellular call by the network and routed to central office 100 via mobile telephone switching office (MTSO) 120 to receive service information, i.e., recorded announcements concerning the sudden service outage.

Thus, users (e.g., 101, 102, 103 . . . n) are connected to a central office 100 through a router 110, a distributing frame 115 and into a switch network 130. In this example, user 101 has dialed a number that requires a recorded announcement from the central office 100. A processor (not shown) recognizes that a user 101 requires a recorded announcement and connects the line through the switch network 130 to a trunk circuit 140 that is in communication with recorded announcement equipment 150. In most arrangements, the recorded announcement equipment is coupled directly to the switch. Typically, this architecture is repeated in one or more central offices throughout a network. Of course, the number and sizes of the central offices will vary, depending upon the size of the overall system, and other considerations.

Under most current situations, recorded announcements are loaded on recorded announcement equipment 150 by the use of a standard conventional audiocassette tapes 153. In some instances, recorded announcements are loaded onto, for example, a laptop personal computer (or a local workstation) 157 and then loaded onto recorded announcement equipment 150 via a cable or other link 155.

Typically, for each recorded announcement there is an assigned trunk, or a path, to switch network 130. This configuration varies somewhat from one switch type to another. However, in the simplest terms, each announcement requires a trunk or path from the recorded announcement equipment 150 to the switch network 130. In switching systems such as the Lucent 1AESS™ and 5ESS™ switches, for example, most of the recorded announcement equipment interfaces with the switch network via an analog trunk circuit. The recorded announcement equipment in these switching systems has a channel for each announcement. This means that each channel is wired to a trunk circuit that also connects to the switch network. Accordingly, when an announcement must be added or changed at a central office, it is first loaded on the recorded announcement equipment 150 and then a trunk is wired into the switch network. The latest vintage of recorded announcement equipment that is used in 5ESS™ switching systems uses a 24-channel T-carrier interface. In this arrangement, all 24 channels of each recorded announcement unit are wired to a T-carrier system that then connects to the switch network. No additional wiring of channels is needed at the time when announcements are added or changed. However, these systems require loading of the announcements and occasional maintenance.

Typically, in each central office, or perhaps in one location for a group of central offices, sets of tapes are maintained so that if for some reason one or more of the announcements becomes corrupted, announcements can be re-recorded from the tape(s) onto the recording announcement equipment 150. Similarly, when new services are added that involve recorded announcements, new tapes are made and delivered to the respective central offices so that they can be loaded onto the appropriate equipment at those central offices.

The recorded announcement equipment in Nortel Networks DMS™ and Siemens EWSD™ switching systems is similar to the latest vintage in 5ESS™ systems in that the equipment connects to the switching network via a multi-channel link. No additional wiring is needed in the DMS™ and EWSD™ switching systems after the equipment is installed. However, these systems also require loading of the announcements and occasional maintenance.

Accordingly, using known systems, inventories of recorded announcements must be maintained for one or more central offices. Furthermore, care must be maintained to ensure consistency of the recorded announcements at all central offices. Another problem is that it is difficult to match recording levels across multiple devices at multiple central offices.

Thus, a need exists for a system and method that can provision recorded announcements on a plurality of recorded announcement equipment (e.g., in one or more central offices) without requiring the burdensome production, distribution, and maintenance of audiocassette tapes.

### SUMMARY OF THE INVENTION

The present invention is a system, method, and apparatus for provisioning announcements onto the recorded announcement equipment of a telecommunications system. In contrast to the tedious method of using announcement audiocassette tapes to load announcements onto recorded announcement equipment, an embodiment of the present invention loads announcements using digital audio files, such as .wav or MP3 files. The digital audio files are stored on a database that is remotely accessible through a computer network, such as an intranet, extranet, or the Internet. In one embodiment, a user downloads the digital audio file corresponding to a desired announcement from the database through the network and onto a computer, and then uploads the announcement from the computer to a particular recorded announcement unit. The uploading can involve a transfer of the digital audio file or the playing of the digital audio file by the computer and the recording of the played announcement by the recorded announcement unit. In another embodiment, a user remotely administers a transfer of the digital recording from the database through a network and to a particular recorded announcement unit.

The recorded announcement equipment can reside in any appropriate node of the telecommunications network. In one embodiment of the present invention, the recorded announcement equipment is contained in a central office. In another embodiment, the recorded announcement equipment is contained in a service node that provides announcements for a plurality of central offices.

In a further embodiment of the present invention, recorded announcements that have already been provisioned on the recorded announcement equipment are downloaded from the equipment and stored in one or both of a computer and a database that is remotely accessible through a computer network. In one implementation of this embodiment, a user downloads a desired announcement from the recorded announcement equipment and onto a computer, and then uploads the announcement from the computer through a network and to a database. In another implementation of this embodiment, a user remotely administers a transfer of a digital recording from a recorded announcement unit through a network and to a database.

### BRIEF DESCRIPTION OF THE DRAWINGS

FIG. 1 is a schematic diagram of an overview of a known telecommunication system implementing a known exemplary recorded announcement architecture.

FIG. 2 is a schematic diagram of an exemplary system for provisioning recorded announcements, according to an embodiment of the present invention.

FIG. 3 is a flowchart illustrating an exemplary method for provisioning recorded announcements, according to an embodiment of the present invention.

FIG. 4A is a flowchart illustrating an exemplary method for remotely locating and retrieving a desired recorded announcement, according to an embodiment of the present invention.

FIG. 4B is a screen image of an exemplary user interface main page through which a user accesses a list of standard announcements, according to an embodiment of the present invention.

FIG. 4C is a screen image of an exemplary user interface page that lists standard recorded announcements, according to an embodiment of the present invention.

FIG. 4D is a screen image of an exemplary user interface of an audio program, according to an embodiment of the present invention.

FIG. 4E is a screen image of the user interface of FIG. 4D, with the “File” menu opened and the “Open” option selected, according to an embodiment of the present invention.

FIG. 4F is a screen image of an exemplary file open window displayed in response to selecting the “Open” option in FIG. 4E, according to an embodiment of the present invention.

FIG. 4G is a screen image of the user interface of FIG. 4D, with a file loaded, according to an embodiment of the present invention.

FIG. 5A is a flowchart illustrating an exemplary method for transmitting an announcement to a local DMS™ switch, according to an embodiment of the present invention.

FIG. 5B is a schematic diagram of an exemplary cable for connecting a computer to a telephone set of a DMS™ switch, according to an embodiment of the present invention.

FIGS. 5C and 5D are images of the cable of FIG. 5B connected to a telephone set, according to an embodiment of the present invention.

FIG. 5E is an image of the speaker unit of an exemplary telephone set, with its microphone disabled, according to an embodiment of the present invention.

FIG. 5F is a screen image of the user interface of FIG. 4G, with a file being played, according to an embodiment of the present invention.

FIG. 6A is a flowchart illustrating an exemplary method for transmitting an announcement to the recorded announcement equipment of a 5ESS™ switch, according to an embodiment of the present invention.

FIG. 6B is an image of a computer connected to the recorded announcement equipment of a 5ESS™ switch, according to an embodiment of the present invention.

FIG. 7A is a flowchart illustrating an exemplary method for transmitting an announcement to the recorded announcement equipment of a 1AESS™ switch, according to an embodiment of the present invention.

FIG. 7B is an image of a computer connected to the recorded announcement equipment of a 1AESS™ switch, according to an embodiment of the present invention.

FIG. 7C is an image of a headset connected to the recorded announcement equipment of a 1AESS™ switch, for confirming the quality of a recording, according to an embodiment of the present invention.

FIG. 8A is a flowchart illustrating an exemplary method for transmitting an announcement to the recorded announcement equipment of an EWSD™ switch, according to an embodiment of the present invention.

FIG. 8B is an image of recorded announcement equipment of an EWSD™ switch, according to an embodiment of the present invention.

FIG. 9A is a flowchart illustrating an exemplary method for saving a recorded announcement from the recorded announcement equipment of a DMS™ switch, according to an embodiment of the present invention.

FIG. 9B is a flowchart illustrating an exemplary method for saving a recorded announcement from the recorded announcement equipment of a DMS™ switch, according to an embodiment of the present invention.

### DETAILED DESCRIPTION OF THE INVENTION

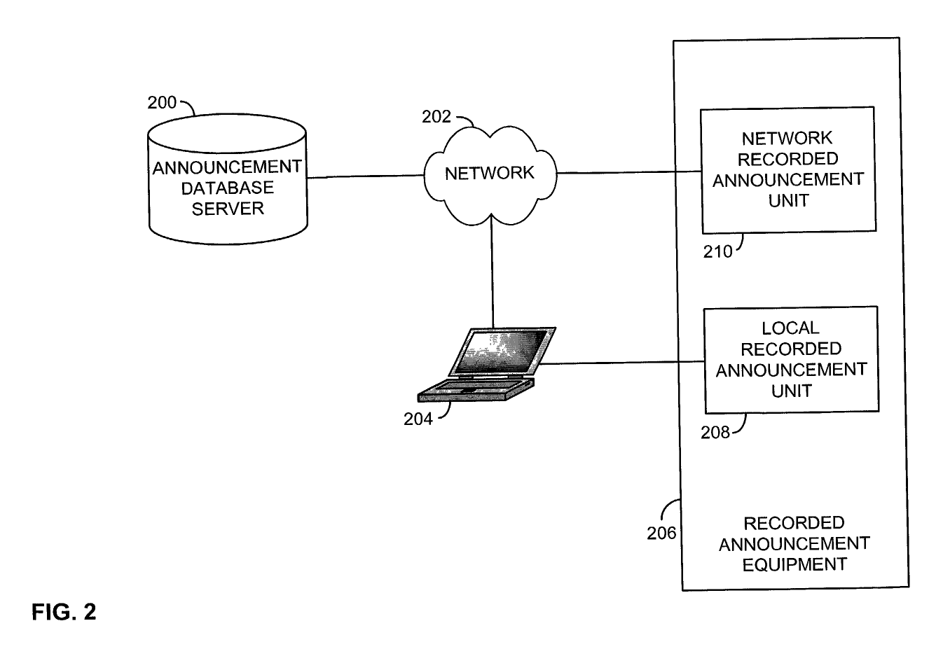

FIG. 2 illustrates an exemplary system for provisioning recorded announcements, according to an embodiment of the present invention. As shown, this exemplary system includes an announcement database server 200, a network 202, a computer 204, and recorded announcement equipment 206.

Announcement database server 200 is a web server that is in communication with network 202 and contains a library of digital recorded announcements. Network 202 is any computer network, such as an intranet, extranet, or the Internet. Computer 204 is in communication with network 202 and is provisioned with software that enables it to locate and remotely access other computers and servers in communication with network 202, such as announcement database server 200. The software could be, for example, network browsing software.

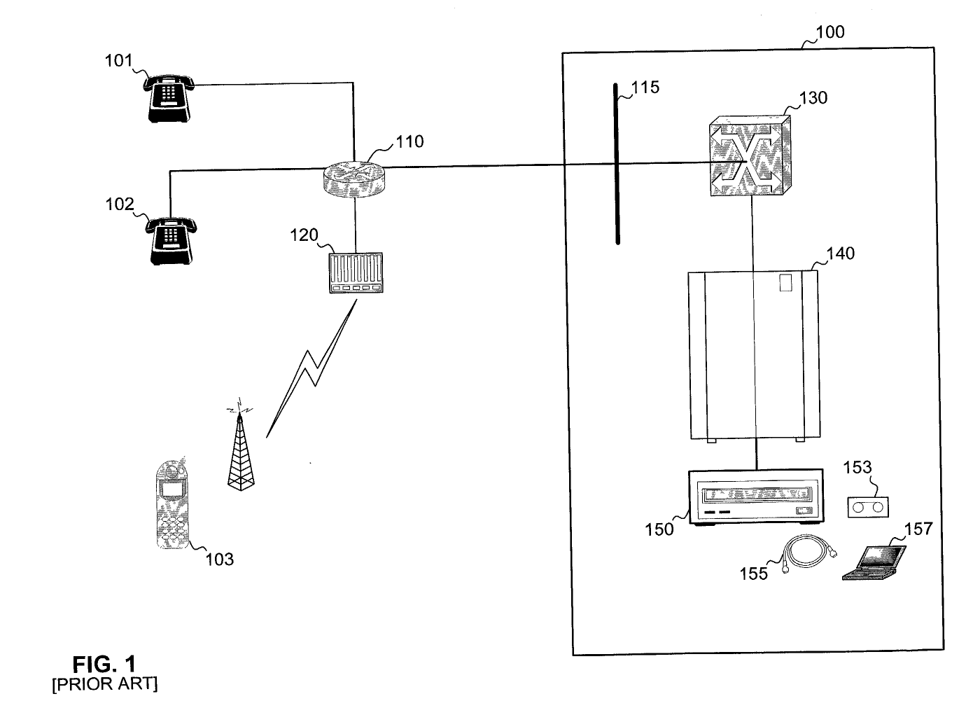

Recorded announcement equipment 206 stores and plays the particular digital recorded announcements required for a portion of a telecommunications network. The portion of the telecommunications network that recorded announcement equipment 206 serves depends on the point at which equipment 206 is provisioned in the telecommunications network. For example, in a traditional implementation such as the system architecture of FIG. 1, recorded announcement equipment 206 (equipment 150 in FIG. 1) is provisioned at a central office (office 100 in FIG. 1) and serves only that central office. In another implementation, recorded announcement equipment 206 is provisioned in an announcement service node that provides announcements for a plurality of central offices. This latter implementation is the subject of the related co-pending application Ser. No. 10/073,238, titled “System and Method for Providing Recorded Messages on a Communications Network,” filed Feb. 13, 2002, which is assigned to the assignees of the present invention and is hereby incorporated by reference in its entirety.

Regardless of where recorded announcement equipment 206 is provisioned, equipment 206 can be configured as a local unit 208 or a network unit 210 or both, depending on its ability to communicate through a computer network. In a local configuration, local recorded announcement unit 208 communicates only with computer 204 through a dedicated cable link. In a network configuration, network recorded announcement unit 210 can communicate through network 202 with computer 204 and announcement database server 200, or any other computer in communication with network 202. Although FIG. 2 shows one local recorded announcement unit 208 and one network recorded announcement unit 210, recorded announcement equipment 206 could, of course, include multiple recorded announcement units. For example, a plurality of local recorded announcement units could be connected to computer 204. Likewise, a plurality of network recorded announcement units could be in communication with network 202.

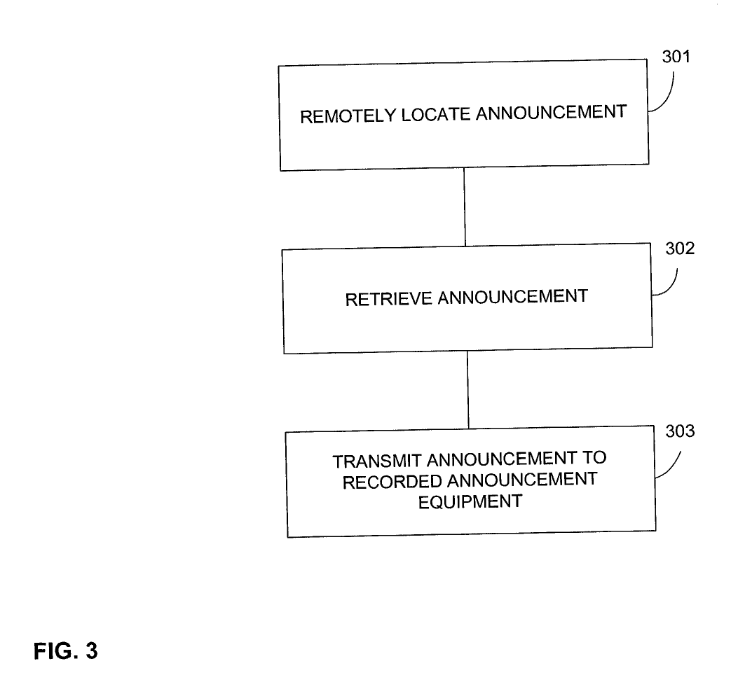

FIG. 3 provides an overview of a method for provisioning announcements according to an embodiment of the present invention. As shown, in step 301, the method begins by remotely locating a desired announcement. With reference to the system architecture of FIG. 2, in this step a user accesses announcement database server 200 through network 202 using computer 204. Through cooperative software provisioned on computer 204, the user can search the announcements stored on server 200 and identify the desired announcement.

In step 302, the desired announcement is retrieved. The particular tasks completed during this retrieval depend on whether the recorded announcement unit on which the announcement is to be loaded is a local recorded announcement unit 208 or a network recorded announcement unit 210. In a first embodiment of the present invention, for a local unit 208, retrieving the desired announcement involves downloading the digital audio file corresponding to the desired announcement. The file is downloaded from announcement database server 200 through network 202 to computer 204. In a second embodiment of the present invention, for a network unit 210, retrieving the desired announcement involves identifying the digital audio file for a file transfer.

Having retrieved the digital audio file of the desired announcement, the method concludes in step 303 by transmitting the file to recorded announcement equipment 206. The particular tasks completed during this transmission again depend on whether the recorded announcement unit on which the announcement is to be loaded is a local recorded announcement unit 208 or a network recorded announcement unit 210. In the first embodiment of the present invention, for a local unit 208, transmitting the desired announcement involves uploading the corresponding digital audio file through a cable link to the local recorded announcement unit 208. In this case, through a direct cable link, the upload is performed on-site at the location of the recorded announcement unit 208. The particular method and apparatus used to upload the file depend on the type of switch (e.g., DMS™, 5ESS™, 1AESS™, or EWSD™) to which unit 208 is connected. Examples of different methods and apparatus are described in more detail below.

In the second embodiment of the present invention, for a network unit 210, transmitting the desired announcement in step 303 involves a user, through computer 204, administering a transfer of the corresponding digital audio file from announcement database server 200 through network 202 to network recorded announcement unit 210. In completing this network file transfer, computer 204 can download the digital audio file that was identified in step 302 from server 200 and through network 202, and then upload the file to network recorded announcement unit 210. Alternatively, computer 204 can direct announcement database server 200 to transfer the identified file directly to network recorded announcement unit 210.

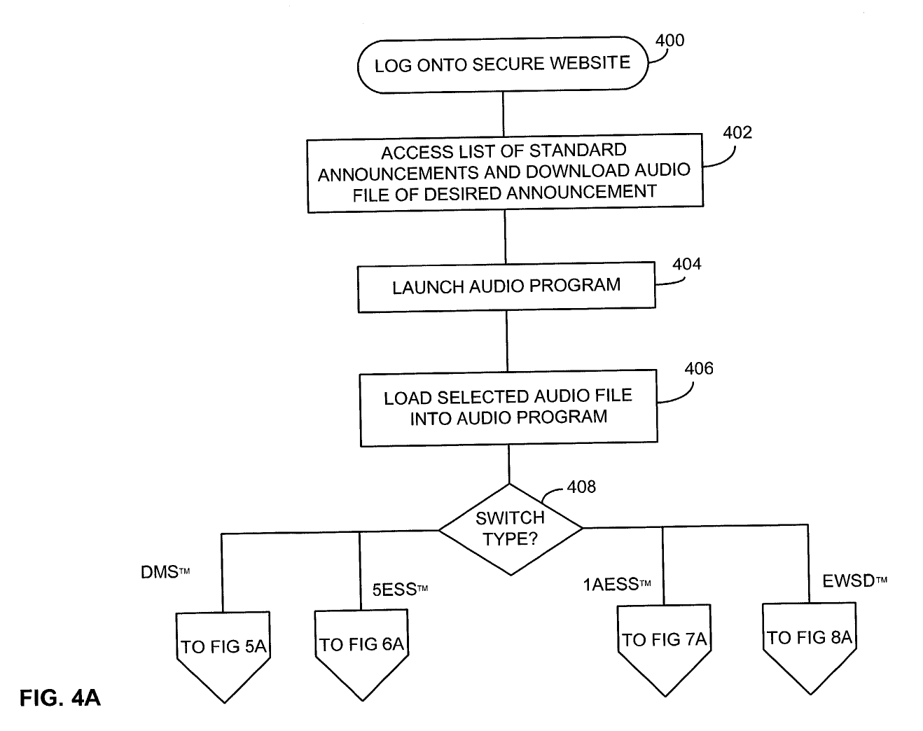

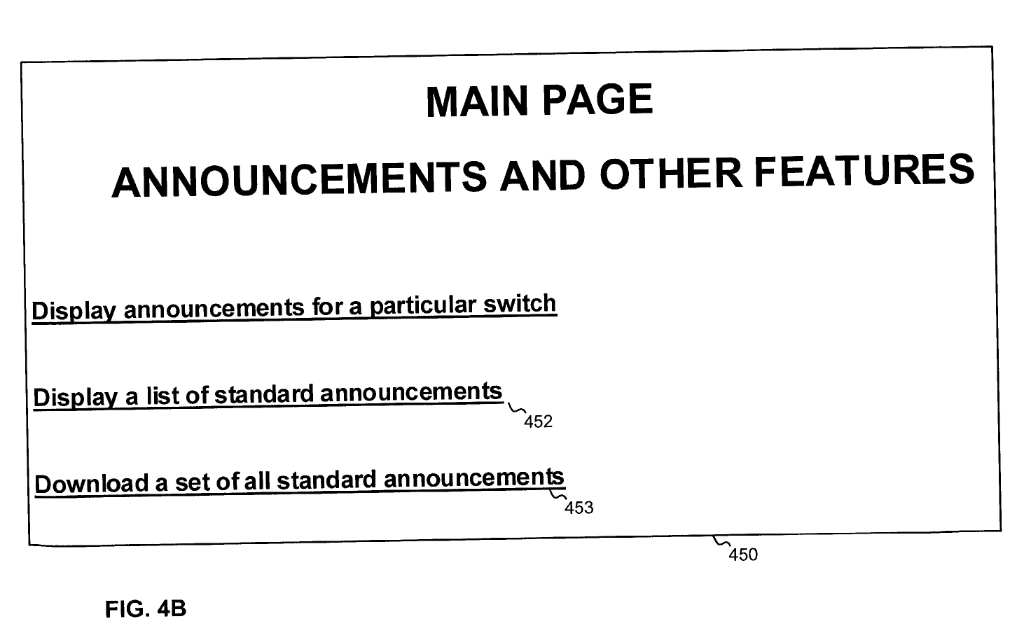

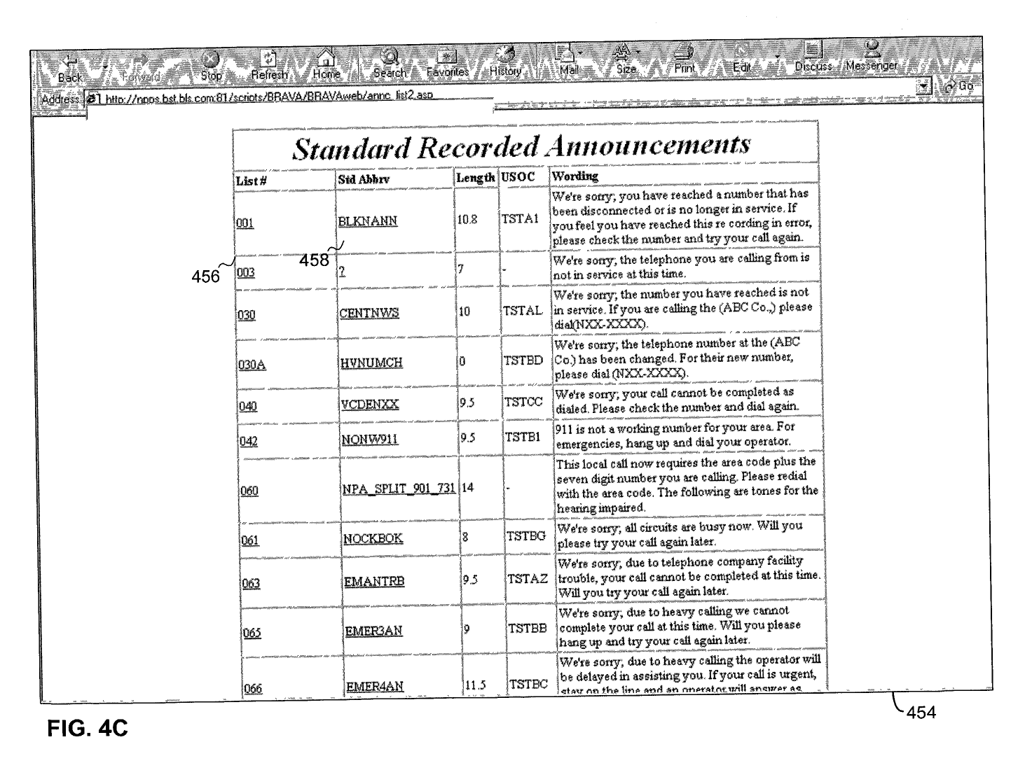

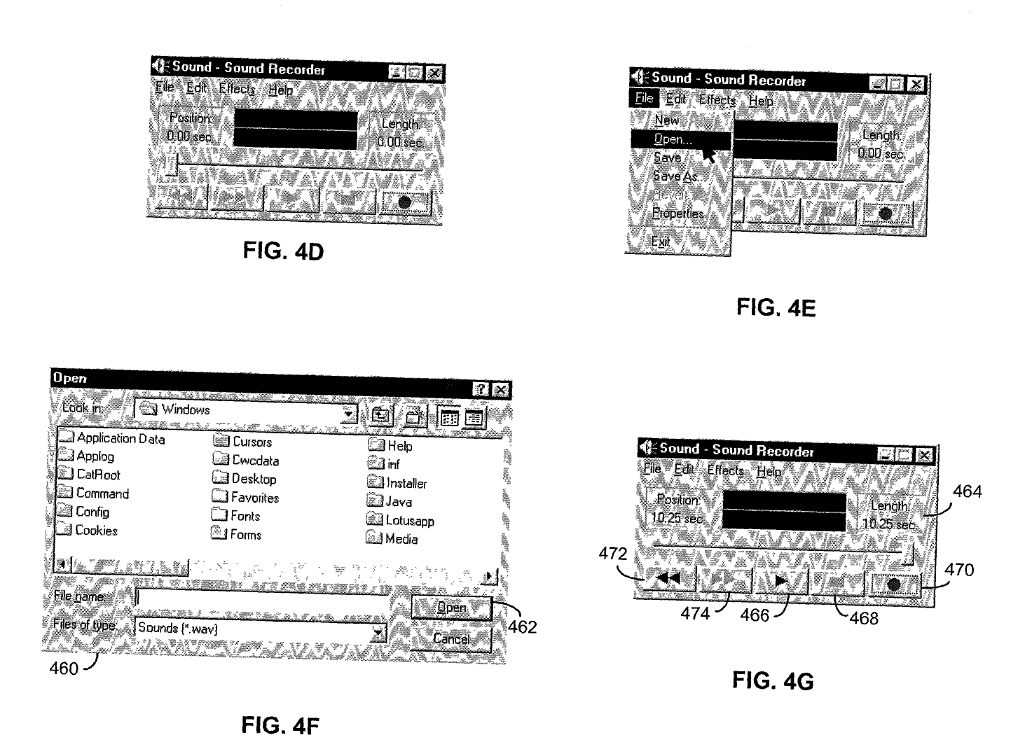

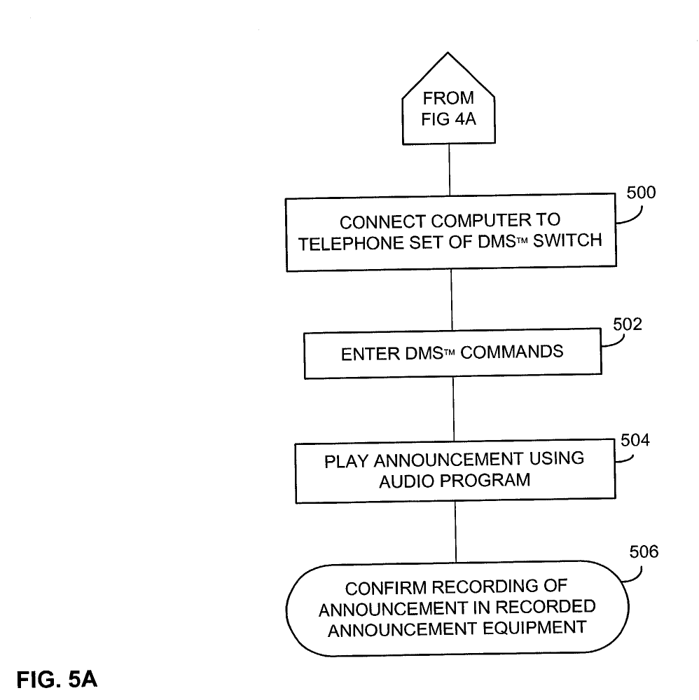

FIGS. 4A-8B illustrate in greater detail the first embodiment of the present invention, in which a recorded announcement is loaded onto local recorded announcement unit 208 through a cable link. In a first implementation of this first embodiment, a recorded announcement is loaded onto the recorded announcement equipment of a DMS™ switch (or another similar switch). DMS™ switches typically have integral recorded announcement equipment (i.e., DRAMs and EDRAMs) that is unique to DMS™ switches. In a second, third, and fourth implementation, a recorded announcement is loaded onto the recorded announcement equipment of a 5ESS™ switch (or other similar switch), a 1AESS™ switch (or other similar switch), and an EWSD™ switch (or other similar switch), respectively. These latter three types of switches are typically compatible with a variety of types of recorded announcement equipment, such as a Cognitronics McIAS (Multi-Channel Intelligent Announcement System) 16XX/IP Voice Processing System, the AT&T Type 13A, 15A, and 16 Announcement Systems™, and the Nortel™ Cook Digital Announcer. With reference to FIG. 3, the tasks involved in remotely locating (step 301) and retrieving (step 302) an announcement are the same for all four implementations (i.e., all switch types). However, the tasks involved in transmitting (step 303) the announcement to the recorded announcement equipment differ, as explained below.

FIGS. 4A-4G illustrate in more detail an exemplary process for remotely locating (step 301 of FIG. 3) and retrieving (step 302 of FIG. 3) a desired announcement, according to an embodiment of the present invention. FIG. 4A outlines the exemplary process in a flowchart. FIGS. 4B-4G illustrate exemplary user interfaces corresponding to the process.

As shown in FIG. 4A, the process begins in step 400 with the user logging onto a secure web site (e.g., using a password and user identification), which displays a main page, such as the exemplary page 450 shown in FIG. 4B. Main page 450 provides a link 452 for displaying a list of standard announcements. With reference to FIG. 2, the user logs onto the web site using computer 204, and communicates through network 202 to access the web site and main page that are served up by announcement database server 200.

In step 402, the user clicks on link 452 to access the list of standard announcements and download a desired announcement. In response, announcement database server 200 serves up a page of recorded announcements, such as page 454 of FIG. 4C. As shown, page 454 provides an exemplary table 456 of standard recorded announcements listed by list number and standard abbreviation. Table 456 also includes exemplary wording for each announcement. By clicking on a link in table 456, such as link 458, a user can download a digital audio file (e.g., a .wav or MP3 file) corresponding to a desired announcement. The user downloads the file to a designated folder on computer 204. The folder can be in any storage device in communication with computer 204, such as a CD ROM drive, a hard drive, or a floppy drive. In addition, if a user needs a complete set of announcements, the user can click on link 453 of FIG. 4B and download a file that contains compressed versions of all of the announcements and then, at a later time, extract individual announcement files as needed.

In step 404, the user launches an audio program that is provisioned on computer 204, such as the audio program provided as part of the multimedia accessories of Microsoft Windows 95™ and NT 4.0™. This audio program plays digital audio files and, optionally, also records sounds as digital audio files. As one of ordinary skill in the art would appreciate, the audio program could be another multimedia program, such as Windows Media Player™ or RealSystem Producer™. FIG. 4D illustrates an exemplary user interface of the audio program. In addition to the audio program, in this embodiment, computer 204 is provisioned with audio hardware necessary to operate the program, such as a sound card, a microphone, a speaker, and audio input and output jacks.

In step 406, the user loads the downloaded digital audio file into the audio program. Specifically, as shown in FIG. 4E, the user clicks on the “Open” option of the “File” menu. In response, the audio program displays a file open window, such as the window 460 shown in FIG. 4F. Using window 460, the user navigates to the designated folder in which the downloaded digital audio file was stored in step 402. After locating the folder, the user selects the file and clicks the “Open” button 462.

In response, as shown in FIG. 4G, the audio program cues the selected digital audio file to its beginning, ready to play. As shown, the exemplary user interface of FIG. 4G includes a length field 464, which displays the duration in seconds of the recording. The interface of the audio program includes control buttons that are similar in function to a conventional tape recorder, for example, a play button 466, a stop button 468, a record button 470, a rewind button 472, and a fast forward button 474. If necessary, the user can also adjust record and playback characteristics using features provided by the audio program. For example, the sound recorder program provided by Microsoft™ allows a user to adjust volume, speed, devices, and recording quality, format, and attributes. In contrast to the conventional audiocassette tapes and players, digital audio programs enable a user to more conveniently set recording levels and the starting and stopping points of recordings.

In an alternative embodiment of the present invention, instead of accessing and downloading an announcement before launching the audio program as shown in steps 402 and 404 of FIG. 4A, the order of these steps could be reversed so that a user launches the audio program first before accessing and downloading the desired digital audio file. Indeed, the user could launch the audio program at any time, even prior to logging onto the web site in step 400, so long as the program is running when the digital audio file is ready to be loaded into the program (step 406). The user could, for example, use the Windows™ taskbar to switch between the audio program interface of FIG. 4D and announcement download page 454 of FIG. 4C, as necessary.

In another alternative embodiment of the present invention, instead of downloading the desired audio file to a folder on computer 204 in step 402 and loading the file from the folder into the audio program in step 406, the audio program is adapted to launch when accessing the announcement file directly from the web site served up by announcement database server 200 through network 202. In other words, the audio program is designated as the program that opens the particular announcement file type. For example, if the announcement files are .wav files and Windows Media Player™ (as the audio program) is the default program designated to open .wav files, then Windows Media Player™ would automatically launch when a .wav announcement file is accessed.

Referring to FIGS. 3 and 4A, the conclusion of step 406 (loading the file into the audio program) corresponds to the end of step 302 (retrieving the announcement). As described above, for the local recorded announcement equipment embodiment, up until this point, the process for remotely locating (step 301) and retrieving (step 302) an announcement is the same for DMS™, 5ESS™, 1AESS™, and EWSD™ switches. With the digital audio file loaded and cued, the exemplary process continues in step 303 with the transmission of the announcement to the recorded announcement equipment. It is at this point that the tasks involved in transmitting the announcement differ between the different types of switches, as represented by step 408 of FIG. 4A.

As shown in FIG. 4A, for a local recorded announcement unit, the particular tasks involved in completing step 303 depend on the type of switch. In one exemplary implementation, for a DMS™ switch, the announcement is transmitted to the switch through a Nortel™ telephone set (or another similar telephone set). In another exemplary implementation, for a 5ESS™ switch, the announcement is transmitted to an AT&T Type 16 Announcement System™ (or another announcement system compatible with a 5ESS™ switch, such as the AT&T Type 13A or 15A Announcement Systems™ or a Nortel™ Cook Digital Announcer. In another exemplary implementation, for a 1AESS™ switch, the announcement is transmitted to an AT&T Type 13A Announcement System™. In a final exemplary implementation, for an EWSD™ switch, the announcement is transmitted to a Cognitronics McIAS 16XX/IP Voice Processing System.

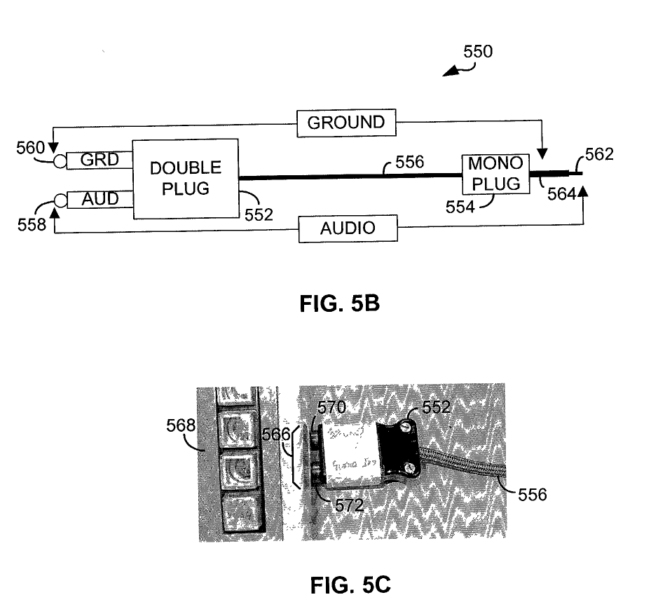

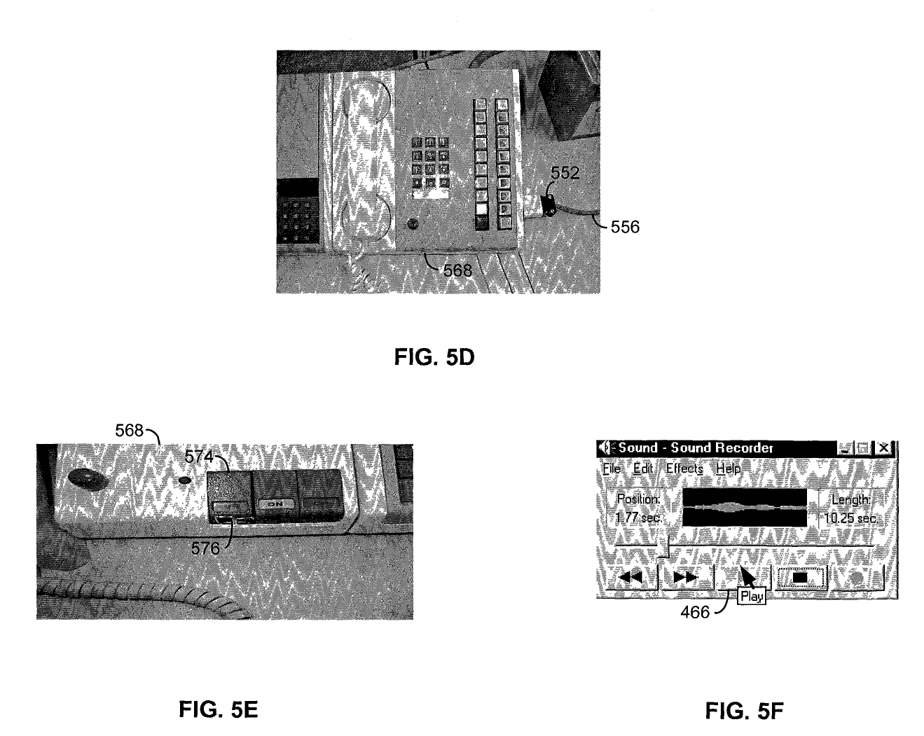

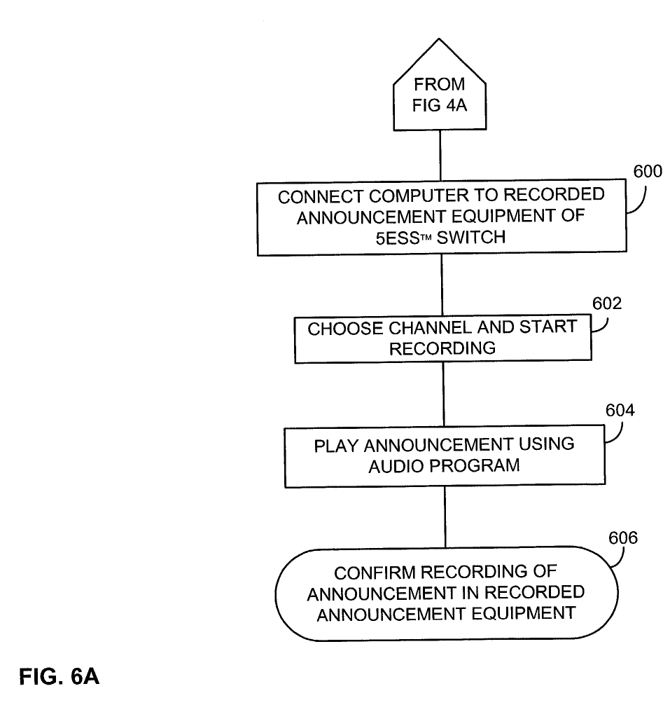

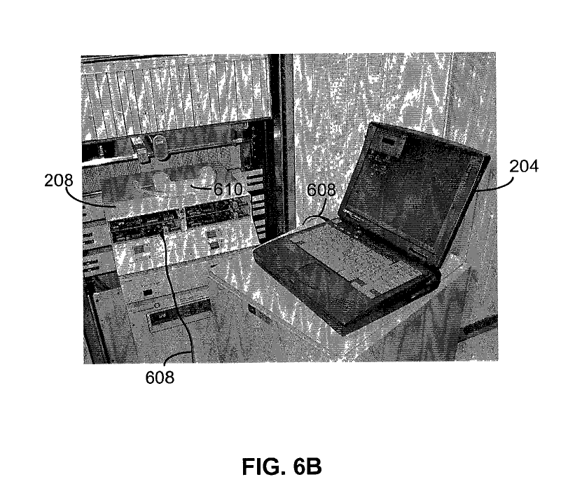

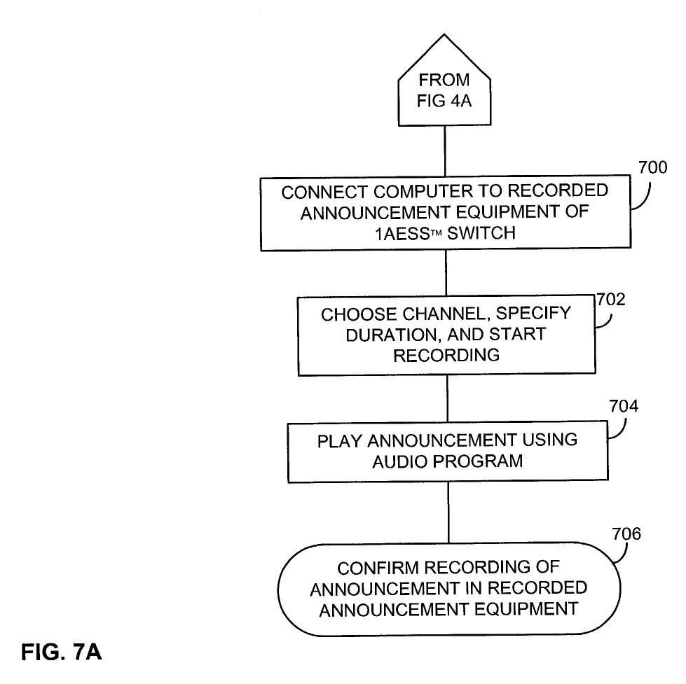

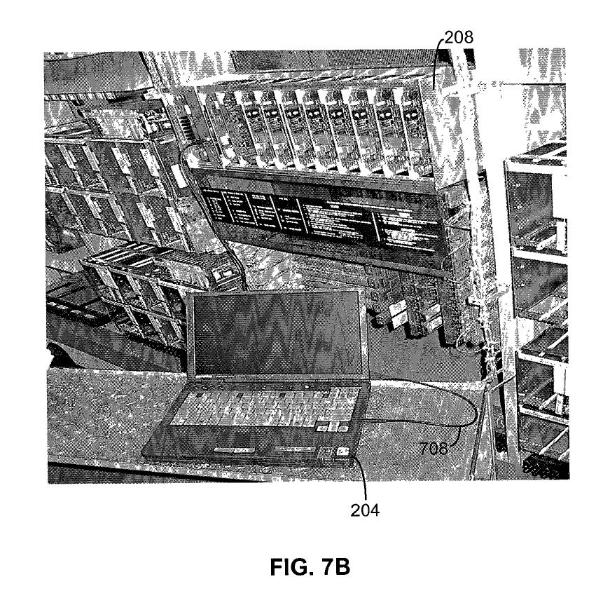

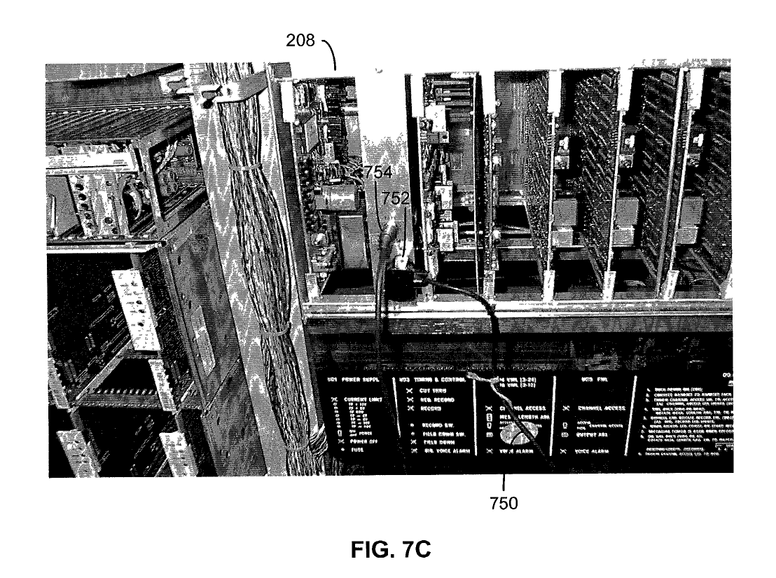

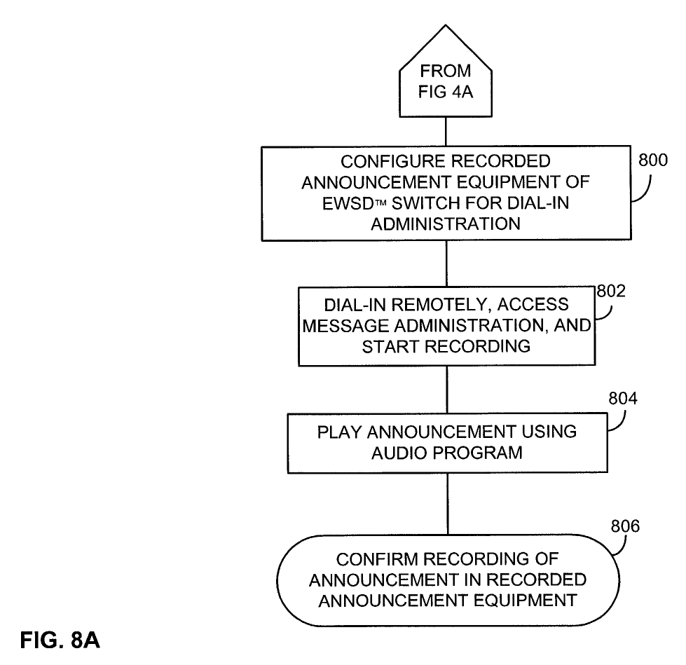

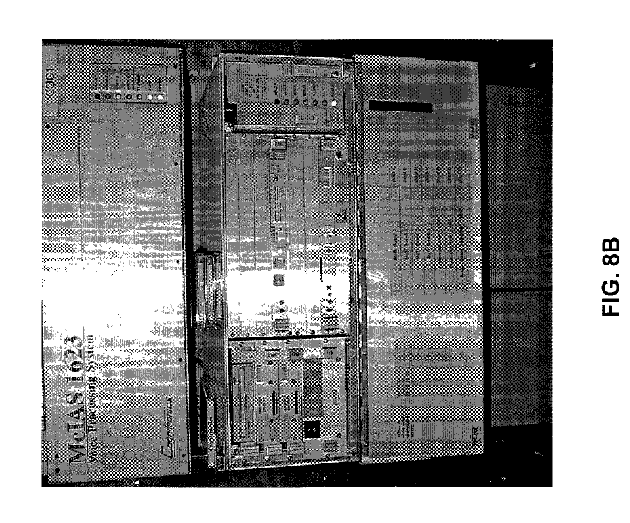

As shown in FIG. 4A, if an announcement is being transmitted to a DMS™ switch, then the exemplary process continues in FIG. 5A. For a 5ESS™ switch, the exemplary process continues in FIG. 6A. For a 1AESS™ switch, the exemplary process continues in FIG. 7A. For an EWSD™ switch, the exemplary process continues in FIG. 8A.

As shown in FIG. 5A, for a DMS™ switch, the process for transmitting the announcement to the local recorded announcement unit begins in step 500 by connecting computer 204 to a telephone set of the DMS™ switch. According to an embodiment of the present invention, this connection is made using the apparatus 550 shown in FIG. 5B. Apparatus 550 includes a shielded cable 556 having a double plug 552 on one side and a plug 554 on the other. Cable 556 is a wire enclosed in a shield. Double plug 552 is compatible with the telephone set of the DMS™ switch. In this example, jack 552 is what is generally referred to as a #464A double plug, which is compatible with a Nortel™ telephone set. Double plug 552 includes two separate conductors 558 and 560.

Plug 554 is compatible with the audio output and input jacks of computer 204 (FIG. 2). In an exemplary implementation, plug 554 is a ⅛″ mono miniplug. As shown in FIG. 5B, the tip 562 of plug 554 is in communication with the audio conductor 558 of jack 552 through the wire of cable 556. The grounded sleeve 564 of plug 554 is in communication with the ground conductor 560 of jack 552 through the shield of cable 556.

In an embodiment of the present invention, apparatus 550 is built using a #464A double plug and a RadioShack™ shielded cable model number 42-2434. As it is sold, one end of the 42-2434 shielded cable includes a ⅛″ miniplug. The other end is stripped to expose tinned ends of the wire and sleeve. The tinned end of the wire is soldered to one conductor of the double plug and serves as the audio conductor. The tinned end of the sleeve is soldered to the other conductor of the double plug and serves as the ground.

Thus, according to an embodiment of the present invention, in step 500, double plug 552 of apparatus 550 is connected to the double jack 566 of a Nortel™ telephone set 568 as shown in FIGS. 5C and 5D. In this example, ground conductor 560 plugs into the top jack 570 of telephone set 568, while audio conductor 558 plugs into the bottom jack 572 of telephone set 568. Plug 554 of apparatus 550 is connected to the audio output jack of computer 204 (not shown). In an exemplary implementation, the audio output jack of computer 204 is a ⅛″ miniplug jack.

If the telephone set has a microphone that automatically activates, then step 500 further includes disabling that microphone. In the specific implementation shown in FIGS. 5C and 5D, Nortel™ telephone set 568 includes a built-in microphone in its speaker unit. Therefore, to eliminate any audio input from the microphone and limit the audio input to jack 566, the built-in microphone must be disabled. FIG. 5E illustrates one exemplary method for disabling the microphone by holding down the mute button 574 of telephone set 568. Mute button 574 can be held down by hand or other means, such as a weight or tape. In the example of FIG. 5E, a paperclip 576 keeps mute button 574 depressed.

Returning to FIG. 5A, with computer 204 connected to the telephone set of the DMS™ switch, the process for transmitting the announcement to the local recorded announcement unit continues in step 502 with the input of commands into the DMS™ switch. These commands ready the switch to record an announcement. As an example, the following commands could be entered in step 502 (command parameters are shown within parentheses):

DRAMREC

CONNECT (dram #) HSET (#)

RECORD (announcement name) (seconds) NOPAD

The DRAMREC command launches the DRAM recording utility. DRAM is an acronym for digital recorder announcement module. The CONNECT command (e.g., “CONNECT 7 HSET 1”) specifies on which piece of equipment (e.g., DRAM and headset) the announcement is to be recorded. Finally, the RECORD command (e.g., “RECORD annc_{—}904_{—}386 17 NOPAD”) specifies the name and duration of the announcement, and causes the recorded announcement unit to record the audio input for the specified duration. The NOPAD command specifies the duration of the pause between hitting the enter key and the start of recording.

Upon entry of the final command in step 502, the DMS™ switch begins recording audio input. In the implementation using telephone set 568, the speaker unit of telephone set 568 emits two tone alerts to signal the start of recording. The switch records signals received through audio jack 572 (and not through the disabled microphone). Thus, simultaneous with the start of recording, or shortly thereafter, in step 504, the announcement that was loaded into the audio program in step 406 is played. As shown in FIG. 5F, the user clicks on play button 466 of the user interface of the audio program. The program then plays the announcement and displays a modulation of the recording.

After the audio program plays the announcement and the DMS™ simultaneously records the announcement, in step 506, the recorded announcement equipment of the DMS™ switch confirms the successful recording of the announcement by repeatedly playing the announcement over the speaker unit of the telephone set. This playback feature allows the user to assess the quality of the recording. At the conclusion of step 506, the desired announcement is loaded into the recorded announcement equipment and ready to play for call scenarios. The end of step 506 therefore marks the end of the method for provisioning the recorded announcement (FIG. 3).

In an alternative embodiment of the present invention, local recorded announcement unit 208 is adapted to play the digital audio files (e.g., .wav or MP3 files) stored on announcement database server 200. The Cognitronics McIAS 16XX/IP Voice Processing System is one example of a recorded announcement unit that has this ability. In this manner, computer 204 does not have to play a selected announcement through its audio program while local recorded announcement unit 208 is recording. Instead, computer 204 can simply download the file from announcement database server 200 and upload the file to local recorded announcement unit 208. Referring to FIGS. 4A, 5A, 6A, 7A, and 8A, this alternative embodiment would replace the steps after step 402. Instead of these steps, after step 402, computer 204 would upload the audio file of the desired announcement to local recorded announcement unit 208.

Returning to FIG. 4A, if in step 408 an announcement is being transmitted to a 5ESS™ switch, then the exemplary process continues in FIG. 6A. As shown in FIG. 6A, for a 5ESS™ switch, the process for transmitting the announcement to the local recorded announcement unit begins in step 600 by connecting computer 204 to the recorded announcement equipment connected to the 5ESS™ switch. According to an embodiment of the present invention, the recorded announcement equipment is an AT&T Type 16 Announcement System™ and the connection is made using a cable compatible with the audio output of computer 204 and the audio input of the AT&T Type 16 Announcement System™. In this example, a suitable cable would be the RadioShack™ shielded cable model number 42-2420A, with ⅛″ miniplugs on both ends. One miniplug plugs into the audio output jack of computer 204. The other miniplug plugs into the audio input jack of the AT&T Type 16 Announcement System™. FIG. 6B illustrates this arrangement, with one end of a ⅛″ cable 608 plugged into the ⅛″ audio output jack of computer 204 and the other end plugged into the ⅛″ audio input/output jack on the front panel of local recorded announcement unit 208.

With cable 608 connected, in step 602 the user selects a channel in which to record the announcement and instructs the recorded announcement unit to begin recording. In an embodiment of the present invention with the AT&T Type 16 Announcement System™, a user follows the exemplary instructions listed below to select the channel and begin recording:

1) Press “Menu” to obtain desired channel;

2) Press “Select” once or twice to take channel off-line;

3) Press “Menu” to obtain record function;

4) Press “Select” to show available time; and

5) Press “Select” to start recording.

At the conclusion of step 602, the recorded announcement unit begins recording signals received through cable 608. Simultaneous with the start of recording, or shortly thereafter, in step 604, the announcement that was loaded into the audio program in step 406 is played. As shown in FIG. 5F, the user clicks on play button 466 of the user interface of the audio program. The audio program then plays the announcement and displays a modulation of the recording. After the audio program plays the announcement completely through, the user instructs the recorded announcement unit to stop recording. Continuing the exemplary instructions from above, with an AT&T Type 16 Announcement System™, the user follows the steps listed below to stop the recording and reset the recorded announcement unit:

1) Press “Select” to stop recording;

2) Press “Select” to monitor recording;

3) Press “Select” to stop monitoring;

4) Press “Menu” twice and “Select” once to put channel on-line; and

5) Press “Menu” to reset recorded announcement unit to be ready to accept a next selection of a desired channel.

After the audio program plays the announcement and the recorded announcement unit records the announcement, in step 606, the recorded announcement unit confirms the successful recording of the announcement by repeatedly playing the announcement. An AT&T Type 16 Announcement System™, for example, repeatedly plays the announcement over the handset 610 as shown in FIG. 6B. In this manner, the user is able to confirm the quality of the recording. At the conclusion of step 606, the desired announcement is loaded into the recorded announcement equipment and is ready to play for call scenarios. The end of step 606 therefore marks the end of the method for provisioning the recorded announcement (FIG. 3).

Returning to FIG. 4A, if in step 408 an announcement is being transmitted to a 1AESS™ switch, then the exemplary process continues in FIG. 7A. As shown in FIG. 7A, the process for transmitting the announcement to the local recorded announcement unit begins in step 700 by connecting computer 204 to the recorded announcement equipment of the 1AESS™ switch. According to an embodiment of the present invention, the recorded announcement equipment is an AT&T Type 13A Announcement System™ and the connection is made using a cable compatible with the audio output of computer 204 and the audio input of the AT&T Type 13A Announcement System™. In this example, a suitable cable would be the RadioShack™ shielded cable model number 42-2420A, with ⅛″ miniplugs on both ends. One miniplug plugs into the audio output jack of computer 204. The other miniplug plugs into the audio input jack of the AT&T Type 13A Announcement System™. FIG. 7B illustrates this arrangement, with one end of a ⅛″ cable 708 plugged into the ⅛″ audio output jack of computer 204 and the other end plugged into the ⅛ audio input/output jack on the front panel of local recorded announcement unit 208.

With cable 708 connected, in step 702 the user throws the “Channel Access” switch on the desired channel unit to the up position (at which point a green “Channel Access” LED illuminates), rotates the “Message Length Adjustment Wheel” to set the desired recording duration (which is presumably equal to or greater than the duration of the desired recorded announcement), and depresses and releases the “Record Switch” on the “Timing and Control” card in the AT&T Type 13A Announcement System™ (e.g., the “UD-3” card).

At the conclusion of step 702, local recorded announcement unit 208 begins recording signals received through cable 708, and the green “Recording” LED of local recorded announcement unit 208 illuminates. Simultaneous with the start of recording, or shortly thereafter, in step 704, the announcement that was loaded into the audio program in step 406 is played. As shown in FIG. 5F, the user clicks on play button 466 of the user interface of the audio program. The program then plays the announcement and displays a modulation of the recording.

When the predetermined recording duration expires, local recorded announcement unit 208 stops recording and the green “Recording” LED goes out. After the audio program plays the announcement and local recorded announcement unit 208 records the announcement, in step 706, the user confirms the quality of the recording. In this specific example, the user attaches a headset to the headset jack of local recorded announcement unit 208 and listens to the recorded announcement. As shown in FIG. 7C, in this example, the headset cable 750 is attached to the headset jack 752, which is located under the ⅛″ audio input/output jack 754 on the front panel of local recorded announcement unit 208. After the user is satisfied with the quality of the recorded announcement (repeating the prior steps if necessary), the user throws the “Channel Access” switch back to normal.

Returning to FIG. 4A, if in step 408 an announcement is being transmitted to an EWSD™ switch, then the exemplary process continues in FIG. 8A. This embodiment enables a user to remotely load recorded announcements from any location that provides access to a telephone line. Thus, this embodiment is suitable for provisioning recorded announcements on a (remote) network recorded announcement unit 210.

As shown in FIG. 8A, the process for transmitting the announcement to the local recorded announcement unit begins in step 800 by configuring the recorded announcement equipment of the EWSD™ switch for dial-in administration. According to an embodiment of the present invention, the recorded announcement equipment is a Cognitronics McIAS 16XX/IP Voice Processing System™ as shown in FIG. 8B, which has been set-up for dial-in administration purposes, with a trunk type set to “ADM” (which is an abbreviation for “administration”). In this example, there is only one administration channel per system.

With the recorded announcement equipment configured for dial-in administration, in step 802 the user dials-in remotely, accesses the message administration function, and starts the recording. Specifically, the user dials the telephone number associated with the channel designated as “ADM.” After hearing the greeting announcement, the user enters a valid password followed by the number sign (#). The recorded announcement unit then plays the message, “Enter your language table, then press number sign (#),” followed by the numbers of the installed vocabulary sets and their current descriptions, if any. In response, the user presses the telephone number key corresponding to the vocabulary set to which the new message will belong and then presses the number sign (#) key. In this particular example, from the main menu, the user presses the number three key to access the message administration function and, from the message administration menu, presses the number five key to begin recording. The user then holds the telephone handset microphone to the speaker of computer 204.

With the dial-in connection complete and the recorded announcement unit recording, in step 804 the announcement that was loaded into the audio program in step 406 is played using the audio program. As shown in FIG. 5F, the user clicks on play button 466 of the user interface of the audio program. The audio program then plays the announcement through the speaker of computer 204 and displays a modulation of the recording. The recorded announcement unit records the announcement through the microphone of the telephone handset (which is held close to the computer speaker). When the announcement is over, the user presses the number sign (#) to stop the recorded announcement unit from recording.

After the audio program plays the announcement and the recorded announcement unit records the announcement, in step 806 the user confirms the quality of the recording. In this specific example, the user presses the number one key to listen to the newly recorded message and, if it is acceptable, presses the number two key to save the message. Finally, the user hangs up the telephone to end the dial-in session. If the recorded announcement equipment is connected to a network, the new message is distributed to all other nodes automatically.

In an alternative embodiment of the EWSD™ switch implementation using the Cognitronics McIAS™ recorded announcement unit, a user transfers digital audio files (e.g., .wav files) directly to the hard drive of the recorded announcement unit through a network, instead of holding the telephone handset to the computer speaker as described above. The McIAS 16XX/IP™ recorded announcement unit can be, for example, networked using an IP address within the subnet router used by the central office switches. As long as a user knows the IP address and password, recorded announcements can be loaded from any access point in the network. In a representative embodiment, a user follows the exemplary instructions listed below to administer this file transfer:

1) Connect computer to McIAS Network using an Ethernet LAN card;

2) Launch Microsoft FTP™ using <START> and then <RUN>, and then type “C:\windows\ftp<McIAS Ethernet Address> and press <ENTER>;

3) User <McIAS Ethernet address (none): Type “Kermit” and then press <ENTER>;

4) Enter password: “xxxx”, then press <ENTER>;

5) fip>Type “bin”, then press <ENTER>;

6) ftp>Type “put AUDIOFILENAME.wav” then press <ENTER>; and

7) ftp>Type “quit”, then press <ENTER>.

A further embodiment of the present invention provides a method for saving a recorded announcement that is already provisioned on a recorded announcement unit. The recorded announcement can be saved on at least one of computer 204 or announcement database server 200. The particular tasks involved in downloading the recorded announcement from the recorded announcement equipment depend upon the type of switch, such as with the DMS™ recorded announcement equipment and the AT&T Type 16 Announcement System™ (for the 5ESS™ switch) described in the two exemplary implementations above.

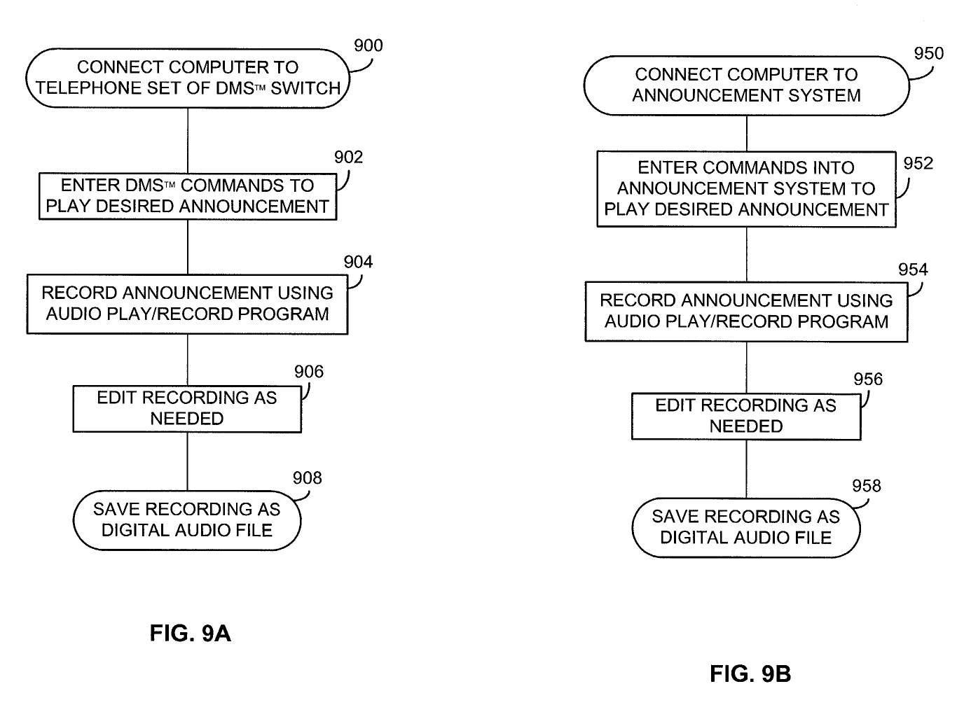

FIG. 9A illustrates an exemplary method for saving a recorded announcement from a DMS™ switch. As shown, in step 900, cable 550 is connected to the audio output of telephone set 568 and the audio input jack (e.g., microphone jack) of computer 204. Plug 554 of cable 550 plugs into the input jack of computer 204. Double plug 552 plugs into jack 566 in the same manner described above in reference to the method for transmitting an announcement to the DMS™ switch.

In step 902, commands are entered into the DMS™ switch instructing the DMS™ switch to play back a specified announcement through the speaker unit of telephone set 568. As an example, the following commands could be entered in step 902 (command parameters are shown within parentheses):

DRAMREC

DISPLAY X

CONNECT (dram#) HSET (#)

PLAYBACK (dram#) (announcement name)

DISCONNECT

The DRAMREC command launches the DRAM recording utility. After entering this command, the user turns the headset button to a horizontal position (on a Nortel™ Logic 20) and pushes the “on” button down on the speaker. The DISPLAY command displays all of the announcement names provisioned on the chosen DRAM. The CONNECT command (e.g., “CONNECT 7 HSET 1”) specifies on which piece of equipment (e.g., DRAM and headset) the announcement is to be played. The PLAYBACK command (e.g., “PLAYBACK 7 annc_{—}904_{—}386”) specifies the DRAM number and name of the announcement, and causes the recorded announcement unit to play the chosen announcement through the chosen equipment (e.g., speaker of the Nortel™ Logic 20). The DISCONNECT command stops the (repeated) playback of the chosen announcement.

In step 904, when the DMS™ switch starts to play the announcement, the record feature of the audio program is activated. For example, referring to FIG. 4G, the user clicks on record button 470 of the user interface of the audio program when the announcement starts to play, and clicks on stop button 468 when the announcement is over.

In step 906, the audio program is used to edit the recording as needed. Once in the desired form, in step 908, the recording is saved into a digital audio file. For example, with the Microsof™ sound recorder program, the user selects the “save as” option from the “File” menu, specifies a file name and directory for the recording, and presses the “OK” button. In saving the recording, the user can choose to store the file on computer 204 or, optionally, can upload the file through network 202 to announcement database server 200. Of course, the file could be stored on one or both of computer 204 and server 200.

FIG. 9B illustrates an exemplary method for saving a recorded announcement from an AT&T Type 16 Announcement System™. As shown, in step 950, cable 608 is connected to the audio input/output jack of the AT&T Type 16 Announcement System™ and the audio input jack (e.g., microphone jack) of computer 204. In an embodiment of the present invention, the plugs of cable 608 and the jacks of the computer and recorded announcement unit are ⅛″ in size.

In step 952, commands are entered into the AT&T Type 16 Announcement System™ instructing the system to monitor (or play back) the recording loaded in a particular channel unit. In an embodiment of the present invention, a user follows the exemplary instructions listed below to select the channel and play back a chosen announcement:

1) Press “Menu” to obtain desired channel;

2) Press “Select” once or twice to take channel off-line;

3) Press “Menu” to obtain monitor function; and

4) Press “Select” to start playback.

In step 954, when the announcement starts to play, the record feature of the audio program is activated. For example, referring to FIG. 4G, the user clicks on record button 470 of the user interface of the audio program when the announcement starts to play, and clicks on stop button 468 when the announcement is over. With the AT&T Type 16 Announcement System™, the user can monitor the start of the announcement by listening through handset 610. Continuing the exemplary instructions from above, the user follows the steps listed below to stop the playback and reset the recorded announcement unit:

1) Press “Select” to stop playback;

2) Press “Menu” twice and “Select” once to put channel on-line; and

3) Press “Menu” to reset recorded announcement unit to be ready to accept next selection of a desired channel.

Finally, in step 956, the audio program is used to edit the recording as needed. Once in the desired form, in step 958, the recording is saved into a digital audio file in the same manner described above in reference to step 908 of FIG. 9A.

Referring again to FIG. 2, as mentioned above, a second embodiment of the present invention uses a network recorded announcement unit 210. An announcement file or files would be downloaded to computer 204 from announcement database server 200. A computer could be directly connected to network recorded announcement unit 210 using an Ethernet Local Area Network (LAN) card or similar device. Alternatively, computer 204 could be connected to a network common to network recorded announcement unit 210. If the Internet Protocol (IP) address and password of network recorded announcement unit 210 is known, communication can be established.

A program that is capable of executing File Transfer Protocol (FTP) commands would be used to establish communication between computer 204 and network recorded announcement unit 210. A software application such as Internet Explorer™ (using the drag and drop feature) could be used to transfer files. Passwords would be used to gain access to network recorded announcement unit 210. Commands would then be entered to transfer a specified file to network recorded announcement unit 210.

Alternatively, a maintenance controller could be used to direct announcement database server 200 to transfer a file directly to network recorded announcement unit 210. The maintenance controller would use similar commands as mentioned above using File Transfer Protocol (FTP) to establish communication between announcement database server 200 and network recorded announcement unit 210. Commands would then be entered to instruct announcement database server 200 to download a specified file to network recorded announcement unit 210.

A further embodiment of the present invention provides a method for saving a recorded announcement that is already provisioned on a network recorded announcement unit. Referring to FIG. 2, a user would use computer 204 to administer a transfer of the recorded announcement from network recorded announcement unit 210 to announcement database server 200. In completing this network file transfer, computer 204 can download the digital audio file from network recorded announcement unit 210 through network 202, and then upload the file to announcement database server 200 through network 202. Alternatively, computer 204 can direct network recorded announcement unit 210 to transfer the identified file directly to announcement database server 200, as set out above.

In accordance with an embodiment of the present invention, instructions adapted to be executed by a processor to perform a method of the present invention are stored on a computer-readable medium. The computer-readable medium can be a device that stores digital information. For example, a computer-readable medium includes a hard disk, a floppy disk, a tape, and a compact disc read-only memory (CD-ROM), all as known in the art for storing software. The computer-readable medium is accessed by a processor suitable for executing instructions adapted to be executed. The term “adapted to be executed” is meant to encompass any instructions that are ready to be executed in their present form (e.g., machine code) by a processor, or require further validation (e.g., compilation, decryption, or provided with an access code, etc.) to be ready to be executed by a processor.

In describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, unless that order is explicitly described as required by the description of the process in the specification. Otherwise, one skilled in the art can readily appreciate that the sequences may be varied and still remain within the spirit and scope of the present invention.

The foregoing disclosure of embodiments of the present invention has been presented for purposes of illustration and description. It is not intended to be exhaustive or to limit the invention to the precise forms disclosed. Many variations and modifications of the embodiments described herein will be obvious to one of ordinary skill in the art in light of the above disclosure. The scope of the invention is to be defined only by the claims appended hereto, and by their equivalents.

What is claimed is:

1. A method for provisioning an announcement on a recorded announcement unit of a telecommunications network comprising:
remotely locating a digital audio file of the announcement in a database server through a computer network; and
transmitting the digital audio file through the computer network to the recorded announcement unit of the telecommunications network.

2. The method of claim 1, wherein remotely locating the digital audio file comprises:
logging onto a secure web site served up by the database server;
accessing a list of announcements posted on the web site by the database server;
choosing an announcement from the list; and
downloading the digital audio file that corresponds to the announcement from the database server through the computer network and onto a computer.

3. The method of claim 2, wherein the recorded announcement unit is adapted to communicate through the computer network, and wherein transmitting the digital audio file comprises uploading the digital audio file from the computer through the computer network and to the recorded announcement unit.

4. The method of claim 1, wherein the recorded announcement unit is adapted to communicate through the computer network, and wherein transmitting the digital audio file comprises transmitting the digital audio file from the database server through the computer network and to the recorded announcement unit.

5. The method of claim 1, wherein transmitting the digital audio file comprises:
downloading the digital audio file through the computer network onto a computer;
placing the computer in communication with the recorded announcement unit; and
uploading the digital audio file to the recorded announcement unit.

6. The method of claim 1, wherein remotely locating the digital audio file comprises identifying the digital audio file for a file transfer, and
wherein transmitting the digital audio file comprises administering, from a computer in communication with the computer network, the file transfer of the identified digital audio file from the database server through the computer network to the recorded announcement unit.

7. The method of claim 6, wherein administering the file transfer comprises downloading the identified digital audio file from the database server through the computer network onto the computer and uploading the identified digital audio file from the computer through the computer network onto the recorded announcement unit.

8. The method of claim 1, wherein the recorded announcement unit is a Cognitronics McIAS 16XX/IP Voice Processing System connected to an EWSD switch.

9. A method for provisioning an announcement on a recorded announcement unit of a telecommunications network comprising:
remotely locating a digital audio file of the announcement in a database server through a computer network;
downloading the digital audio file that corresponds to the announcement from the database server through the computer network and onto a computer;
launching an audio program on the computer;
loading the digital audio file into the audio program;
placing the computer in communication with the recorded announcement unit;
playing the digital audio file with the audio program; and
recording the announcement with the recorded announcement unit.

10. The method of claim 9, wherein remotely locating the digital audio file comprises:
logging onto a secure web site served up by the database server;
accessing a list of announcements posted on the web site by the database server;
choosing an announcement from the list; and
downloading the digital audio file that corresponds to the announcement from the database server through the computer network and onto a computer.

11. The method of claim 9, further comprising confirming the recording of the digital audio file in the recorded announcement unit.

12. The method of claim 9, wherein placing the computer in communication with the recorded announcement unit comprises connecting a cable to an audio output jack of the computer and an audio input jack of the recorded announcement unit.

13. The method of claim 12, wherein the recorded announcement unit is a recorded announcement unit of a DMS switch, and wherein the audio input jack is a double jack of a telephone set of the DMS switch.

14. The method of claim 13, wherein the telephone set has a speaker unit with a microphone, and the method further comprises disabling the microphone.

15. The method of claim 9, wherein the recorded announcement unit is an AT&T Type 16 Announcement System connected to a 5ESS switch.

16. The method of claim 9, wherein the recorded announcement unit is a recorded announcement unit of a DMS switch.

17. The method of claim 9, wherein the recorded announcement unit is an AT&T Type 13A Announcement System connected to a 1AESS switch.

18. The method of claim 9, wherein placing the computer in communication with the recorded announcement unit comprises dialing into the recorded announcement unit.

19. The method of claim 18, wherein the recorded announcement unit is a Cognitronics McIAS 16XX/IP Voice Processing System connected to an EWSD switch.

20. A system for provisioning a recorded announcement comprising:
(a) an announcement database server that contains a digital audio file corresponding to the recorded announcement;
(b) a computer in communication with the announcement database server through a computer network, wherein the computer is adapted to retrieve the digital audio file from the database server and to play the recorded announcement from the digital audio file; and
(c) a recorded announcement unit in communication with the computer, wherein the recorded announcement unit is adapted to record the recorded announcement.

21. The system of claim 20, further comprising a cable connecting the computer to the recorded announcement unit, the cable comprising:
(i) a wire having a first end and a second end, wherein the wire is enclosed in a shield;
(ii) a mono plug attached to the first end of the wire, wherein the mono plug has a sleeve in communication with the shield and a tip in communication with the wire, and wherein the mono plug is adapted to connect to the computer; and
(iii) a double plug attached to the second end of the wire, wherein the double plug has a first conductor and a second conductor, wherein the first conductor is in communication with the wire, wherein the second conductor is in communication with the shield, and wherein the double plug is adapted to attach to a double jack of a DMS telephone set.

22. The system of claim 20, wherein the recorded announcement unit is provisioned at one of a central office and an announcement service node that provides announcements for a plurality of central offices.

23. A system for provisioning a recorded announcement comprising:
(a) an announcement database server that contains a digital audio file corresponding to the recorded announcement;
(b) a computer in communication with the announcement database server through a computer network; and
(c) a recorded announcement unit in communication with the computer,
wherein the computer is adapted to transfer the digital audio file from the announcement database server through the computer network and to the recorded announcement unit.

24. The system of claim 23, wherein the computer is adapted to download the digital audio file from the announcement database server through the computer network and to upload the digital audio file through the computer network and to the recorded announcement unit.

25. The system of claim 23, wherein the recorded announcement unit is in communication with the computer network.

26. The system of claim 25, wherein the computer is adapted to upload the digital audio file through the computer network and to the recorded announcement unit.

27. The system of claim 23, wherein the computer is further adapted to transfer a digital audio file that exists on the recorded announcement unit from the recorded announcement unit through the computer network and to the announcement database server.

28. The system of claim 23, wherein the recorded announcement unit is provisioned at one of a central office and an announcement service node that provides announcements for a plurality of central offices.

29. An apparatus for connecting a computer to a telephone set of a DMS switch to upload recorded announcements from the computer to the switch comprising:
(a) a wire having a first end and a second end, wherein the wire is enclosed in a shield;
(b) a mono plug attached to the first end of the wire, wherein the mono plug has a sleeve in communication with the shield and a tip in communication with the wire; and
(c) a double plug attached to the second end of the wire, wherein the double plug has a first conductor and a second conductor, wherein the first conductor is in communication with the wire, wherein the second conductor is in communication with the shield.

30. The apparatus of claim 29, wherein the double plug is a 464A double plug.

31. The apparatus of claim 29, wherein the mono plug is a ⅛″ miniplug.

32. A system for provisioning recorded announcements on recorded announcement equipment of a telecommunications network comprising:
(a) a database server in communication with a computer network, wherein the database server contains a plurality of digital audio files, and wherein each file of the plurality of digital audio files corresponds to a recorded announcement;
(b) a computer in communication with the database server through the computer network; and
(c) a plurality of recorded announcement units in communication with the computer network,
wherein the computer is adapted to transfer desired digital audio files from the database server through the computer network and to the plurality of recorded announcement units.

33. The system of claim 32, wherein the computer is adapted to download the desired digital audio files from the database server through the computer network and to upload the desired digital audio files through the computer network and to the plurality of recorded announcement units.

34. The system of claim 32, wherein the computer is adapted to transmit the desired digital audio files from the database server through the computer network and to the plurality of recorded announcement units.

35. The system of claim 32, wherein each recorded announcement unit of the plurality of recorded announcement units is provisioned at one of a central office and an announcement service node that provides announcements for a plurality of central offices.

36. A method for saving an announcement from a recorded announcement unit comprising:
placing the recorded announcement unit in communication with a computer having an audio program;
playing the announcement with the recorded announcement unit;
recording the announcement in the computer using the audio program;
saving the recorded announcement in the computer as a digital audio file;
uploading the digital audio file from the computer through a computer network to a database server; and
storing the digital audio file on the database server.

37. The method of claim 36, wherein before saving the recorded announcement, the method further comprises editing the recorded announcement with the audio program.

38. The method of claim 36, wherein placing the recorded announcement unit in communication with the computer comprises connecting a cable to an audio input jack of the computer and an audio output jack of the recorded announcement unit.

39. The method of claim 38, wherein the recorded announcement unit is a recorded announcement unit of a DMS switch, and wherein the audio output jack is a double jack of a telephone set of the DMS switch.

40. A computer-readable medium storing a plurality of instructions adapted to be executed by a processor for provisioning an announcement on a recorded announcement unit of a telecommunications network, the plurality of instructions comprising instructions to:
locate, through a computer network, a web site served up by a database server;
display a list of digital audio files stored on the database server;
receive a selection of the digital audio file corresponding to the announcement; and
transmit the digital audio file through the computer network from the database server to the recorded announcement unit.

41. A method for provisioning an announcement on a recorded announcement unit of a telecommunications network comprising:
remotely locating a digital audio file of the announcement in a database server through a computer network;
downloading the digital audio file from the database server through the computer network to a computer in communication with the computer network; and
uploading the digital audio file from the computer to the recorded announcement unit.

42. The method of claim 41, wherein uploading the digital audio file comprises:
loading the digital audio file into an audio program provisioned on the computer;
playing the digital audio file with the audio program; and
recording the announcement onto the recorded announcement unit.

43. The method of claim 42, further comprising confirming the recording of the announcement onto the recorded announcement unit.
